(19) United States
(12) Patent Application Publication
(10) Pub. No.: US 2015/0123814 A1
(43) Pub. Date: May 7, 2015

(54) Gas Meter Reading System and Meter Reading Method

(71) Applicant: c/o NIPPON GAS CO., LTD., Tokyo (JP)

(72) Inventors: Shinji Wada, Tokyo (JP); Shingo Dekamo, Tokyo (JP)

(21) Appl. No.: 14/406,308

(22) PCT Filed: Jun. 7, 2013
(86) PCT No.: PCT/JP2013/003620

§ 371 Date: Dec. 8, 2014

(30) Foreign Application Priority Data
Jun. 8, 2012 (JP) 2012-130617

(51) Int. Cl. G01D 4/00; H04Q 9/00

(52) U.S. Cl. CPC G01D 4/002; H04Q 9/00
USPC 340/870.03

(57) ABSTRACT

A delivery server includes: a reception unit of receiving meter indication data of an existing gas meter and meter indication data of a new gas meter from a mobile terminal; a modification unit causing the new gas meter to be managed as a gas meter to be managed that is installed in a supply facility; and a meter reading processing unit performing a gas meter reading processing for the supply facility, when meter indication data of the new gas meter on a current meter indication date from the mobile terminal after gas meter replacement, on the basis of the received meter indication data, respective meter indication data of the new gas meter and the existing gas meter in the gas meter replacement, and meter indication data of the existing gas meter in the supply facility on a previous meter indication date of earlier than the gas meter replacement.

### TECHNICAL FIELD

The present invention relates to a system for and a method of performing a meter reading processing with use of a meter indication of a gas meter.

### BACKGROUND ART

It is known that supply of LP gas is based on imports from gas producing countries and domestic production as a by-product in the course of producing petroleum products. Petroleum refining terminals and import terminals for storing LP gas carried from gas producing countries by tankers are respectively referred to as primary terminals. LP gas is loaded into domestic vessels and/or tank trucks in the primary terminals and is shipped to secondary terminals located on the coast or inland as hub terminals for LP gas transportation. Further, LP gas carried to the secondary terminals is transported to LP gas filling stations in various locations, i.e., delivery branches, and is then injected into gas cylinders (gas canisters) in the delivery branches.

The gas cylinders, filled with LP gas in the respective filling stations, are delivered to customers' places such as residential houses, apartment houses and work places by deliverymen. Empty gas cylinders in the customers' places are replaced with full gas cylinders, and are brought back to the respective filling stations. In each filling station, a fixed delivery area is assigned to each deliveryman as an area of which he/she is in charge. Each deliveryman is given delivery tickets to be delivered to customers' places within his/her responsible delivery area in 2 to 10 days.

The delivery tickets are created by a delivery manager. First, the amount of LP gas remaining in each gas cylinder is predicted based on a past gas usage record of each customer, a meter indication of a gas meter in each customer's place, a delivery record and so forth, and the next delivery due date of each gas cylinder is determined. The number of gas cylinders to be delivered in 2 to 10 days is determined by accumulating the number of gas cylinders of all the customers within the delivery area of which each deliveryman is in charge.

In replacing a gas cylinder based on a delivery ticket, a deliveryman fills in the respective items of the delivery ticket including a replacement date, a meter indication on the date, a cylinder number and a safety inspection. When a daily delivery work is finished, delivery tickets are handed in to the delivery manager. The delivery manager checks if each delivery ticket returned to him/her includes incomplete items, and then, stores each checked delivery ticket as data for calculating the next delivery due date. Under the aforementioned method, a system for enhancing efficiency in delivery of a gas cylinder has been proposed (see PTL 1).

As disclosed in PTL 1, a conventional system exists for enhancing efficiency in delivery of a gas cylinder, but no system exists which is configured to receive meter indicative gas usage of gas meters installed before and after gas meter replacement in performing the gas meter replacement, and thereby, to quickly perform a meter reading processing in accordance with the meter indications after the gas meter replacement.

### CITATION LIST

### Patent Literature

PTL 1: Japan Patent Laid-Open No. H08-329159(1996)

### SUMMARY OF INVENTION

### Technical Problem

In view of the aforementioned situation, it is an object of the present invention to provide a gas meter reading system and a meter reading method whereby, even when a gas meter is replaced, a meter reading process can be quickly performed in accordance with meter indications of gas meters.

### Solution to Problem

To solve the aforementioned problem, the present invention relates to a gas meter reading system for performing a gas meter reading process for detecting gas usage in each of a plurality of supply facilities, and the gas meter reading system includes: a management unit that is configured to manage a single or plurality of sets of meter indication data of each of a plurality of gas meters installed in the plurality of supply facilities; a reception unit that is configured to receive a set of meter indication data of an existing gas meter and a set of meter indication data of a new gas meter from a communication terminal when gas meter replacement is performed; a modification unit that is configured to cause the management unit to manage the new gas meter as a gas meter to be managed that is installed in a corresponding one of the plurality of supply facilities; and a meter reading processing unit that is configured to perform the gas meter reading processing for the corresponding one of the plurality of supply facilities when the reception unit receives a set of meter indication data of the new gas meter in the corresponding one of the plurality of supply facilities on a current meter indication date from the communication terminal after the gas meter replacement, with the gas meter reading processing being configured to be performed based on the received set of meter indication data, respective sets of meter indication data of the new gas meter and the existing gas meter in the gas meter replacement, and a set of meter indication data of the existing gas meter in the corresponding one of the plurality of supply facilities on a previous meter indication date of earlier than the gas meter replacement.

Furthermore, to solve the aforementioned problem, the present invention relates to a meter reading method in which a computer performs a gas meter reading process in accordance with gas meter replacement, wherein the computer includes a management unit configured to manage a single or plurality of sets of meter indication data of each of a plurality of gas meters installed in a plurality of supply facilities, and the meter reading method includes the steps of: receiving a set of meter indication data of an existing gas meter and a set of meter indication data of a new gas meter from a communication terminal when the gas meter replacement is performed; causing the management unit to manage the new gas meter as a gas meter to be managed that is installed in a corresponding one of the plurality of supply facilities; and performing the gas meter reading processing for the corresponding one of the plurality of supply facilities when a set of meter indication data of the new gas meter in the corresponding one of the plurality of supply facilities on a current meter indication date is received from the communication terminal after the gas meter replacement, with the gas meter reading processing being configured to be performed based on the received set of meter indication data, respective sets of meter indication data of the new gas meter and the existing gas meter in the gas meter replacement, and a set of meter indication data of the existing gas meter in the corresponding one of the plurality of supply facilities on a previous meter indication date of earlier than the gas meter replacement.

According to the present invention, it is possible to quickly perform a meter reading processing in accordance with meter indications of gas meters even when a gas meter is replaced.

### BRIEF DESCRIPTION OF DRAWINGS

FIG. 1 is a diagram showing an exemplary network configuration according to an exemplary embodiment of the present invention;

FIG. 2 is a block diagram showing an exemplary configuration of a delivery server in FIG. 1;

FIG. 3 is a diagram showing an exemplary structure of customer information stored in a storage device of the delivery server in FIG. 1;

FIG. 4 is a diagram showing an exemplary structure of information that includes a remaining gas amount and is stored in the storage device of the delivery server in FIG. 1;

FIG. 5 is a flowchart showing an exemplary entire operation of the delivery server according to the exemplary embodiment of the present invention;

FIG. 6 is a diagram showing an exemplary operating screen when a mobile terminal in FIG. 1 transmits respective sets of meter indication data in gas meter replacement;

FIG. 7 is a diagram showing exemplary meter indication data; and

FIG. 8 is a diagram showing an exemplary structure of multiple sets of meter indication data stored in the storage device of the delivery server in FIG. 1.

### DESCRIPTION OF EMBODIMENTS

Explanation will be hereinafter provided for a schematic configuration of a system in the present exemplary embodiment. The present system is configured to perform a gas meter reading process for a supply facility in performing gas meter replacement by use of sets of meter indication data including meter indications of gas meters installed before and after the replacement.

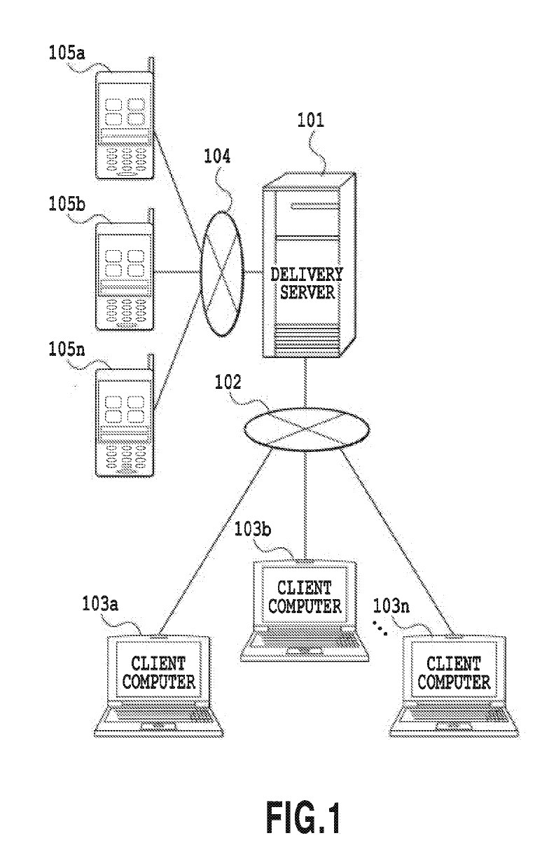

FIG. 1 is a diagram showing a network configuration according to the exemplary embodiment of the present invention. In FIG. 1, a delivery server (gas meter reading system) 101 is configured to communicate with multiple client computers 103a, 103b . . . 103n through a network 102. Further, the delivery server 101 is configured to communicate with multiple mobile terminals (communication terminals) 105a, 105b . . . 105n through a network 104. It should be noted that the multiple client computers 103a-103n are collectively referred to as client computers 103, and the multiple mobile terminals 105a-105n are collectively referred to as mobile terminals 105.

The client computers 103 are terminals that are located in a delivery center for managing deliveries from the respective delivery branches in a unified manner, for instance, and are used by users in the delivery center. A user establishes a connection to the delivery server 101 through a client computer 103 and exclusively performs various delivery tasks such as confirmation of a delivery status and an instruction to creating delivery data. It should be noted that the client computers 103 may be located in, for instance, delivery branches or other locations.

The mobile terminals 105 are terminals to be used by workers (including e.g., meter readers, deliverymen, safety inspectors, etc.) who check meter indications of gas meters respectively installed in the supply facilities equipped with gas cylinders. The mobile terminals 105 respectively include a CPU, a memory, an input device, a display device and so forth. The aforementioned workers collect sets of meter indication data, respectively including a meter indication of each gas meter, using the mobile terminals 105 and transmit the collected sets of meter indication data to the delivery server 101. It should be noted that each set of meter indication data is transmitted to the delivery server 101, for instance, the reading a gas meter, the opening/closing of a valve, the conducting of a safety inspection, the delivery of one or more gas cylinders, the replacement of a gas meter for another, and so forth.

### [Configuration of Delivery Server]

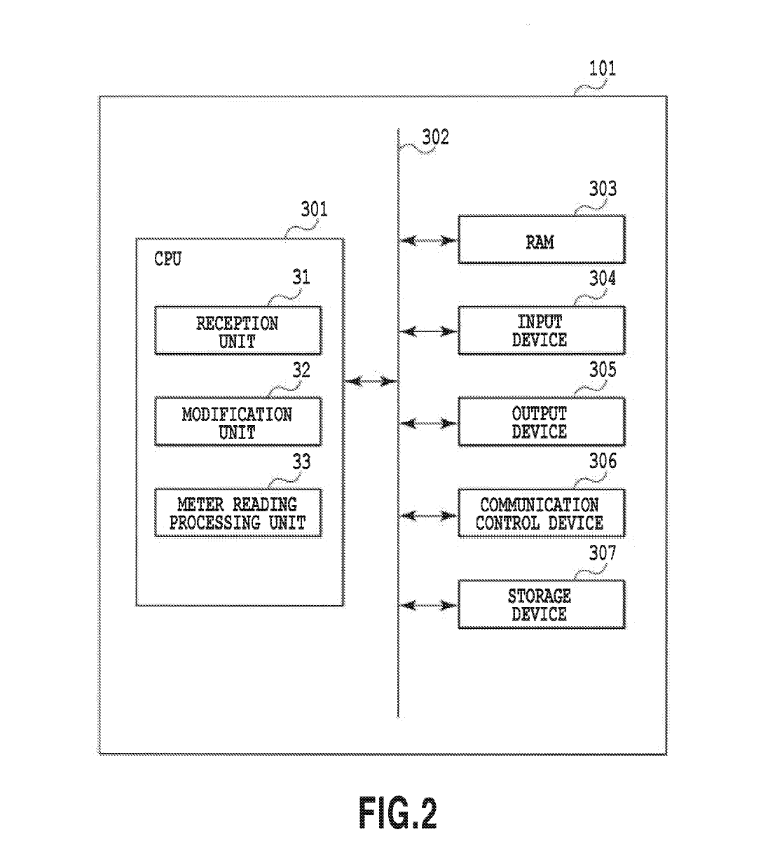

FIG. 2 is a block diagram showing an exemplary configuration of the delivery server 101. It should be noted that FIG. 2 explains a configuration employing a single computer system, but the delivery server 101 can be configured as a part of a multifunctional distribution system comprising multiple computer systems.

As shown in FIG. 2, the delivery server 101 includes a CPU 301, a system bus 302, a RAM 303, an input device 304, an output device 305, a communication control device 306 and a storage device (management unit) 307.

The CPU 301 is coupled to the respective component elements through the system bus 302, and is configured to perform processing for transferring control signals and data. Also, the CPU 301 is configured to run various software programs and perform arithmetic and logic processing and so forth in order to implement operation of the entire delivery server 101.

The RAM 303 has a work area for storing temporarily data and the software programs.

The storage device 307 includes a non-volatile storage medium such as a ROM or a HDD, and has a program storage area for storing the software programs and a data storage area for storing data to be obtained on an as-needed basis, data as processing results, and so forth. For example, a software program is retrieved from the program storage area of the storage device 307 into the work area of the RAM 303, and is run by the CPU 301. Thus, the CPU 301 of the present exemplary embodiment implements functions of respective units 31 to 33 to be described.

As shown in FIG. 2, the CPU 301 includes a reception unit 31, a modification unit 32 and a meter reading processing unit 33.

The reception unit 31 is configured to receive meter indication data of a gas meter for detecting the gas usage in a gas cylinder installed in a supply facility. The indication data is transmitted from a given mobile terminal 105. The meter indication data includes a meter indication of gas usage in the gas cylinder, a meter indication date, and so forth. Detailed explanation thereof will be described below.

Further, in the present exemplary embodiment, the reception unit 31 is configured to receive meter indication data of an existing gas meter and meter indication data of a new gas meter from the mobile terminal 105 when gas meter replacement is performed.

The modification unit 32 is configured enables the storage device 307 to manage a new gas meter based on the meter indication data received by the reception unit 31 as a gas meter to be managed that is installed the supply facility.

When receiving meter indication data of the new gas meter for the supply facility on the current meter indication date from the mobile terminal 105 after gas meter replacement, the meter reading processing unit 33 is configured to perform a gas meter reading process for the supply facility on the basis of the received meter indication data, respective sets of meter indication data of the existing gas meter and the new gas meter in gas meter replacement, and meter indication data of the existing gas meter for this same supply facility on the previous meter indication date of earlier than gas meter replacement. For example, a processing of calculating a gas usage and a processing of calculating a remaining gas amount may be employed as the gas meter reading processing.

### [Process of Calculating Gas Usage]

In the processing for calculating gas usage, the gas consumed in a period from the previous meter indication date to the current meter indication date is calculated based on {(a meter indication included in meter indication data on the current meter reading date)−(a meter indication included in meter indication data of a new gas meter in gas meter replacement)}+{(a meter indication included in meter indication data of an existing gas meter in gas meter replacement)−(a meter indication included in meter indication data of the existing gas meter on the previous meter reading date of earlier than gas meter replacement)}.

### [Process of Calculating Remaining Gas Amount]

In the process of calculating the remaining gas amount, the remaining gas amount on the current meter indication dale is calculated based on {(a remaining gas amount in a gas cylinder installed in a supply facility)−(the gas usage obtained in the aforementioned processing of calculating the gas usage)}.

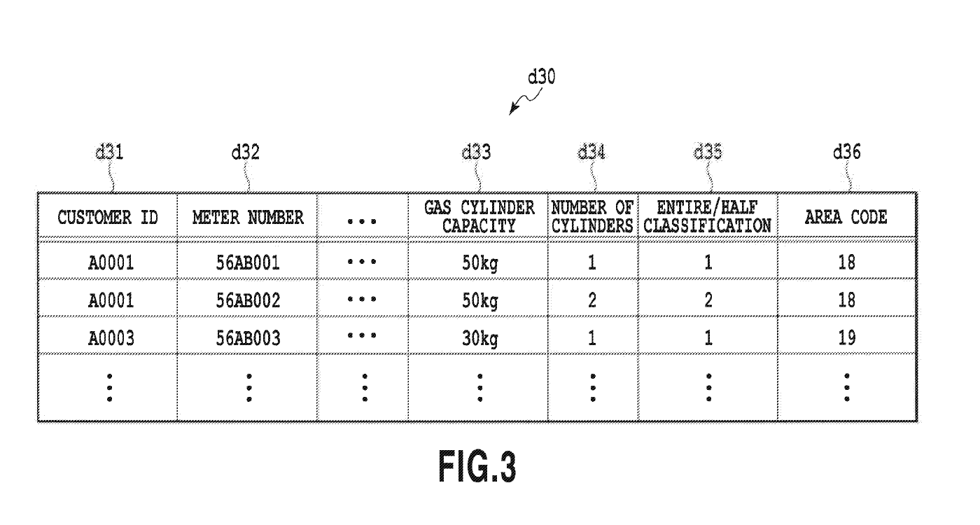

FIG. 3 is a diagram showing an exemplary structure of customer information d30 stored in the storage device 307 of the delivery server 101. As shown in FIG. 3, items stored in the storage device 307 include “customer ID” d31 for identifying each customer, “meter number” d32 for identifying each gas meter, and so forth. Further, items stored in the storage device 307 include “gas cylinder capacity” d33 indicating the capacity of each gas cylinder installed in each supply facility, “number of cylinders” d34 indicating the number of gas cylinders installed in each supply facility, “entire/half classification” d35 indicating whether or not a gas cylinder group composed of two banks of one or more gas cylinders should be entirely replaced, and “area code” d36 for identifying each area that one or more supply facilities are installed. In the example of FIG. 3, “1” is assigned as the value of “entire/half classification” d35 when entire replacement is performed, whereas “2” is assigned as the value of “entire/half classification” d35 when half replacement is performed. When “1” indicating entire replacement is assigned, this means that the first bank of gas cylinder (or cylinders) is also replaced when the second bank of gas cylinder (or cylinders) is replaced. When “2” indicating half replacement is assigned, this means that the gas cylinders are replaced one by one.

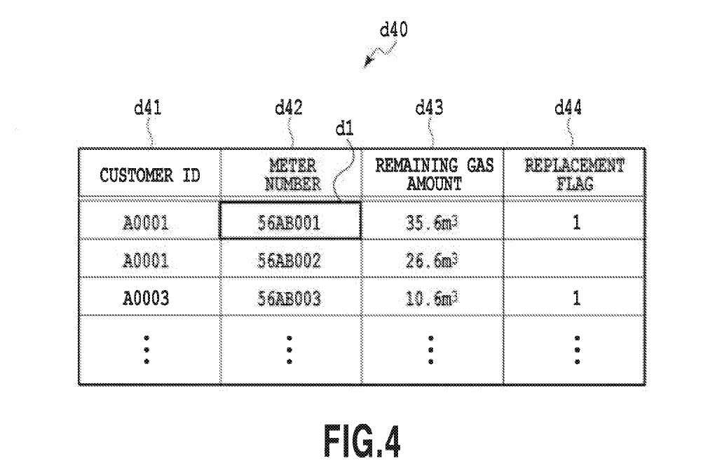

FIG. 4 is a diagram showing an exemplary structure of information including the remaining gas amount, stored in the storage device 307 of the delivery server 101. As shown in a table d40 of FIG. 4, items stored in the storage device 307 include the aforementioned “customer ID” d41, the aforementioned “meter number” d42, “remaining gas amount” d43 and “replacement flag” d44. The “remaining gas amount” d43 indicates the remaining gas amount in a gas cylinder currently used. The “replacement flag” d44 is information indicating whether or not the currently used gas cylinder should be replaced when the remaining gas amount of the currently used gas cylinder reaches a predetermined value. For example, as to half replacement where two gas cylinders are installed in a supply facility, gas may be supplied from the second gas cylinder when the first gas cylinder becomes empty (if an automatic switch device is installed). Thus, a replacement flag is required for determining whether or not gas cylinder delivery is required. In the “replacement flag” 44d, “1” indicates that the currently used gas cylinder is intended for replacement.

It should be noted that in FIG. 4, the meter number of a gas meter, denoted by a reference d1, is “56AB001”.

### [Action of Delivery Server]

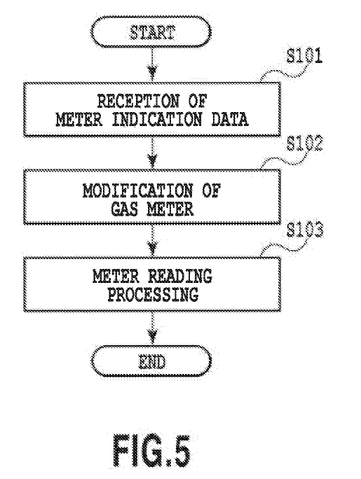

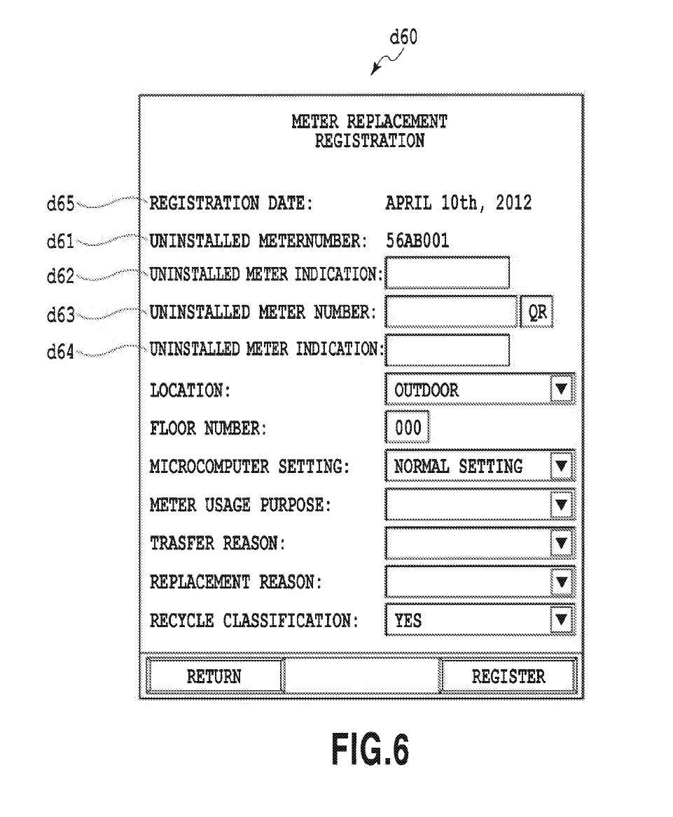

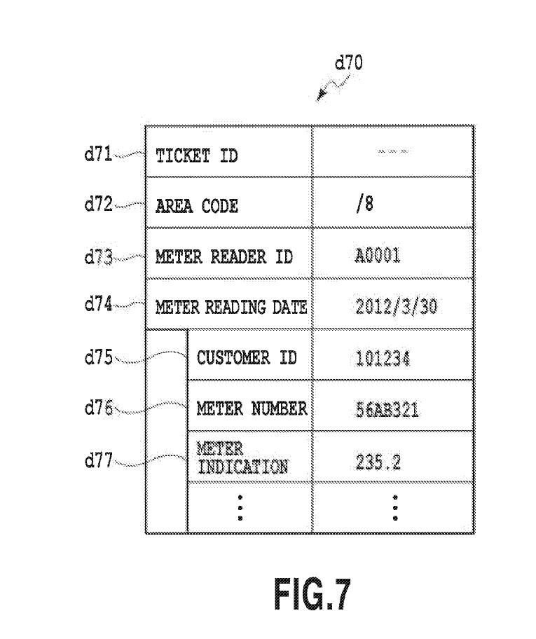

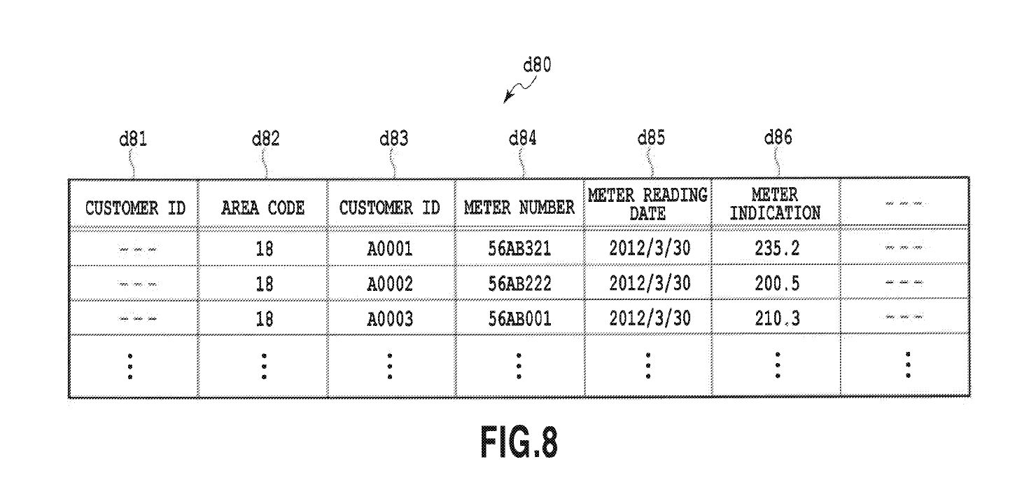

Next, with reference to FIGS. 5 to 8, explanation will be provided for a method of performing a gas meter reading process with use of a set of meter indication data of an existing gas meter installed in a supply facility (gas cylinder) and a set of meter indication data of a new gas meter when the respective sets of meter indication data are transmitted to the delivery server 101 from a given mobile terminal 105 when replacing the existing gas meter to the new gas meter. FIG. 5 is a flowchart showing an exemplary entire action of the delivery server 101. FIG. 6 is a diagram showing an exemplary display screen when the mobile terminal 105 transmits respective sets of meter indication data when replacing a gas meter, whereas FIG. 7 is exemplary meter indication data. FIG. 8 is a diagram showing an exemplary structure of multiple sets of meter indication data stored in the storage device 307 of the delivery server 101.

Firstly in FIG. 5, when the mobile terminal 105 transmits a set of meter indication data of the existing gas meter and that of the new gas meter to the delivery server 101, the CPU 301 (the reception unit 31) of the delivery server 101 is configured to receive the respective sets of meter indication data (S101). Now, FIG. 6 shows an exemplary operating screen to be displayed when the mobile terminal 105 transmits the respective sets of meter indication data in gas meter replacement.

As shown in FIG. 6, an operating screen d60 includes, for instance, uninstalled meter number (meaning “the meter number of the existing gas meter”) d61, uninstalled meter indication (meaning “the meter indication of the existing gas meter”) d62, installed meter number (meaning “the meter number of the new gas meter”) d63, installed meter indication (meaning “the meter indication of the new gas meter”) d64, and so forth. In the explanation of the present exemplary embodiment, a set of data including the detached meter number and the uninstalled meter indication is referred to as a set of meter indication data of the existing gas meter in gas meter replacement. On the other hand, a set of data including the installed meter number and the installed meter indication is referred to as a set of meter indication data of the new gas meter in gas meter replacement. Thus, the respective sets of meter indication data of the gas meters being installed before and after replacement can be transmitted to the delivery server 101 as associated with each other.

In the present exemplary embodiment, a QR code (registered trademark) (readable information code), for instance, is attached to each of the existing and new gas meters. Hence, the mobile terminal 105 is configured to be capable of obtaining the aforementioned detached meter number and attached meter number by reading the QR code (registered trademark). It should be noted that the aforementioned uninstalled meter indication and installed meter indication are obtained based on, for instance, an input operation by a worker. Further, the date on which the QR code (registered trademark) is read, for instance, is set as registration date d65 on the “meter replacement registration” screen d60 exemplified in FIG. 6, i.e., as the timing of gas meter replacement.

When receiving the aforementioned respective sets of meter indication data, the CPU 301 (the modification unit 32) of the delivery server 101 is configured to modify the new gas meter as a gas meter to be managed that is installed in the relevant supply facility on the basis of the respective sets of meter indication data and cause the storage device 307 to manage the gas meter to be managed (S102). When the existing gas meter is managed as a gas meter with the meter number “56AB001” (denoted by the reference d1 in FIG. 4) in the storage device 307, the meter number is modified into a meter number included in the meter indication data of the new gas meter. Thus, the meter indication of the existing gas meter and that of the new gas meter in gas meter replacement are respectively managed.

In S103 of FIG. 5, the CPU 301 (the meter reading processing unit 33) of the delivery server 101 is configured to perform a gas meter reading processing for the supply facility when receiving, for instance, the meter indication data of the new gas meter on the current meter reading date (meter indication date) from the mobile terminal 105 after the aforementioned gas meter replacement, i.e., on and after the processing of S102. The meter reading processing is configured to be performed based on the aforementioned set of meter indication data on the current meter reading date, the aforementioned sets of meter indication data of the new gas meter and the existing gas meter that are received in S101, and a set of meter indication data of the existing gas meter received, for instance, on the previous meter reading date (meter indication date) of earlier than the processing of S101 (indication data on the previous meter reading date).

For example, when the aforementioned gas meter indication processing is calculation of the gas usage, the CPU 301 is configured to calculate the gas usage consumed in the supply facility (gas cylinder) in a period from the previous meter Indication to the current meter indication on the basis of {(a meter indication included in the meter indication data on the current meter reading date)−(a meter indication included in the meter indication data of the new gas meter received in S101)}+{(a meter indication included in the meter indication data of the existing gas meter received in S101)−(a meter indication of the meter indication data on the previous meter reading date)}. Thus, even when gas meter replacement is performed, the gas usage can be quickly and accurately obtained for the supply facility.

It should be noted that the aforementioned sets of meter indication data are all stored in the storage device 307, and relevant sets of meter indication data are read out from the storage device 307 in the processing of S103.

As shown in FIG. 7, sets of meter indication data d70 on the current and previous meter reading dates herein respectively include meter reading ticket ID d71, area code d72, meter reader ID d73, meter reading date d74, customer ID d75, meter number d76, meter indication d77 and so forth. In the present exemplary embodiment, the QR code (registered trademark) (readable information code), for instance, is attached to the gas meter. Hence, the mobile terminal 105 is configured to be capable of obtaining each set of meter indication data excluding a meter indication and a meter reading date by reading the QR code (registered trademark). It should be noted that the meter indication shown in FIG. 7 is obtained based on, for instance, an input operation by a meter reader, whereas the date on which the QR code (registered trademark) is read, for instance, is set as the meter reading date.

In the present exemplary embodiment, when receiving the meter indication data on the meter reading date from the mobile terminal 105, the CPU 301 (the reception unit 31) of the delivery server 101 is configured to cause the storage device 307 to store the meter indication data. FIG. 8 shows exemplary stored data.

As shown in a table d80 of FIG. 8, multiple sets of meter indication data, received by the CPU 301, are stored in the storage device 307. The table d80 includes customer ID d81, area code d82, customer ID d83, meter number d84, meter reading date d85 and meter indication d86.

It should be noted that in S103 of FIG. 5, when the aforementioned gas meter indication processing is calculation of the remaining gas amount, the CPU 301 is configured to subtract the gas usage obtained in the aforementioned gas usage calculation from the remaining gas amount in the supply facility managed by the storage device 307, and is configured to set “the remaining gas amount” in the storage device 307 as a post-subtraction value. Accordingly, even when gas meter replacement is performed, the remaining gas amount can be quickly and accurately obtained for the supply facility.

As explained above, when gas meter replacement is performed, the delivery server 101 of the present exemplary embodiment is configured to manage the new gas meter as a gas meter to be managed and receive the respective sets of meter indication data of the existing gas meter and the new gas meter from the mobile terminal 105 on a real-time basis. Further, the delivery server 101 is configured to perform the meter reading processing for the same supply facility by use of the received sets of meter indication data. Therefore, even when gas meter replacement is performed, the meter reading processing can be quickly performed in accordance with the meter indications of gas meters.

The exemplary embodiment has been explained above, but specific data structures and so forth are not limited to those described in the exemplary embodiment and may be changed. For example, S103 in FIG. 5 shows an example that the delivery server 101 is configured to receive the respective sets of meter indication data on the current and previous meter reading dates. However, the delivery server 101 may be configured to receive meter indication data in opening/closing a gas valve, in conducting a safety inspection or in delivering a gas cylinder.

1. A gas meter reading system for performing a gas meter reading processing of detecting a gas usage in each of a plurality of supply facilities, comprising:
a management unit configured to manage a single or plurality of sets of meter indication data of each of a plurality of gas meters installed in the plurality of supply facilities;
a reception unit configured to receive from a communication terminal a set of meter indication data of an existing gas meter and a set of meter indication data of a new gas meter with a screen for replacing a gas meter when gas meter replacement is performed, the screen including the set of meter indication data of the existing gas meter and new gas meter, and information relating to a replacement reason for the existing gas meter, the screen is further configured visibly to display a plurality of menu items indicative of a different content with respect to one another, each menu item is configured such that the corresponding content is selected with pull-down, the items include a location, microcomputer setting, a meter usage purpose, a transfer reason, the replacement reason and a recycle classification;
a modification unit configured to cause the management unit to manage the new gas meter as a gas meter to be managed that is installed in a corresponding one of the plurality of supply facilities; and
a meter reading processing unit configured to perform the gas meter reading processing for the corresponding one of the plurality of supply facilities when the reception unit receives a set of meter indication data of the new gas meter in the corresponding one of the plurality of supply facilities on a current meter indication date from the communication terminal after the gas meter replacement, with the gas meter reading processing configured to be performed based on the received set of meter indication data, respective sets of meter indication data of the new gas meter and the existing gas meter in the gas meter replacement, and a set of meter indication data of the existing gas meter in the corresponding one of the plurality of supply facilities on a previous meter indication date of earlier than the gas meter replacement.

2. A meter reading method of causing a computer to perform a gas meter reading processing in accordance with gas meter replacement, the computer including a management unit configured to manage a single or plurality of sets of meter indication data of each of a plurality of gas meters installed in a plurality of supply facilities, the meter reading method comprising:
receiving from a communication terminal a set of meter indication data of an existing gas meter and a set of meter indication data of a new gas meter with a screen for replacing a gas meter when the gas meter replacement is performed, the screen including the set of meter indication data of the existing gas meter and new gas meter, and information relating to a replacement reason for the existing gas meter, the screen is further configured visibly to display a plurality of menu items indicative of a different content with respect to one another, each menu item is configured such that the corresponding content is selected with pull-down, the items include a location, microcomputer setting, a meter usage purpose, a transfer reason, the replacement reason and a recycle classification;
causing the management unit to manage the new gas meter as a gas meter to be managed that is installed in a corresponding one of the plurality of supply facilities; and
performing the gas meter reading processing for the corresponding one of the plurality of supply facilities when a set of meter indication data of the new gas meter in the corresponding one of the plurality of supply facilities on a current meter indication date is received from the communication terminal after the gas meter replacement, with the gas meter reading processing configured to be performed based on the received set of meter indication data, respective sets of meter indication data of the new gas meter and the existing gas meter in the gas meter replacement, and a set of meter indication data of the existing gas meter in the corresponding one of the plurality of supply facilities on a previous meter indication date of earlier than the gas meter replacement.

3. A computer readable storage medium storing a program for causing the computer to execute the meter reading method, the meter reading method causes a computer to perform a gas meter reading processing in accordance with gas meter replacement, the computer including a management unit configured to manage a single or plurality of sets of meter indication data of each of a plurality of gas meters installed in a plurality of supply facilities, the meter reading method comprising:
receiving from a communication terminal a set of meter indication data of an existing gas meter and a set of meter indication data of a new gas meter from a communication terminal with a screen for replacing a gas meter when the gas meter replacement is performed, the screen including the set of meter indication data of the existing gas meter and new gas meter, and information relating to a replacement reason for the existing gas meter, the screen is further configured visibly to display a plurality of menu items indicative of a different content with respect to one another, each menu item is configured such that the corresponding content is selected with pull-down, the items include a location, microcomputer setting, a meter usage purpose, a transfer reason, the replacement reason and a recycle classification;
causing the management unit to manage the new gas meter as a gas meter to be managed that is installed in a corresponding one of the plurality of supply facilities; and
performing the gas meter reading processing for the corresponding one of the plurality of supply facilities when a set of meter indication data of the new gas meter in the corresponding one of the plurality of supply facilities on a current meter indication date is received from the communication terminal after the gas meter replacement, with the gas meter reading processing configured to be performed based on the received set of meter indication data, respective sets of meter indication data of the new gas meter and the existing gas meter in the gas meter replacement, and a set of meter indication data of the existing gas meter in the corresponding one of the plurality of supply facilities on a previous meter indication date of earlier than the gas meter replacement.

4. The gas meter reading system according to claim 1, wherein in case the supply facilities include a plurality of gas cylinders, the management unit is further to manage a replacement information indicating whether or not all gas cylinders or a part of gas cylinders should be replaced when the cylinder gets empty during use, and
the management unit is configured to store information for indicating the new gas meter in relation to the replacement information when the new gas meter is managed by the modification unit.
